(19) United States
(12) Patent Application Publication
(10) Pub. No.: US 2008/0009262 A1
(43) Pub. Date: Jan. 10, 2008

(54) METHOD AND APPARATUS FOR SUPPORTING AN EMERGENCY CALL IN A WIRELESS METROPOLITAN AREA NETWORK

(75) Inventors: Marian Rudolf, Vitre (FR); Ronald G. Murias, Calgary (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/746,999

(22) Filed: May 10, 2007

Related U.S. Application Data
(60) Provisional application No. 60/799,760, filed on May 12, 2006.

(51) Int. Cl. H04M 11/04

(52) U.S. Cl. 455/404.1

(57) ABSTRACT

A method and apparatus for supporting an emergency call in a wireless communication system including a wireless metropolitan area network (WMAN) are disclosed. A wireless transmit/receive unit (WTRU) sends an emergency call message to a base station of the WMAN to make an emergency call along with an emergency call indication. The base station then admits the emergency call with or without performing a security procedure and connects the WTRU to an emergency call center. The base station and the WTRU may communicate capability information regarding support of emergency calls. Location information of the WTRU is also forwarded to the emergency call center. The base station may work as a proxy for the WTRU if the WTRU does not have all the required functionalities to complete the emergency call. The WTRU may be a multi-mode WTRU capable of communicating with two or more radio access networks (RANs).

### CROSS REFERENCE TO RELATED APPLICATION

This application claims the benefit of U.S. Provisional Application No. 60/799,760 filed May 12, 2006, which is incorporated by reference as if fully set forth.

### FIELD OF INVENTION

The present invention is related to wireless communication systems. More particularly, the present invention is related to a method and apparatus for supporting an emergency call in a wireless communication system including a wireless metropolitan area network (WMAN).

### BACKGROUND

Conventional IEEE 802.xx networks, (e.g., IEEE 802.11 wireless local area networks (WLANs), IEEE 802.15 wireless personal area networks (WPANs), IEEE 802.16 or IEEE 802.20 WMANs, or the like), do not have to provide support for emergency calls like a cellular network does. For the cellular network, support of emergency calls is widely implemented which is often resulted from regulatory requirements. Support for emergency calls involves many aspects across all communication layers, especially signaling support and mandated procedures, which are non-existent for IEEE 802.xx networks. With the advent of voice over Internet protocol (VoIP) and increased everyday usage of wireless networks, support for emergency calls in the IEEE 802.xx networks is necessary.

A fixed VoIP phone service has a limited emergency call support. However, for the fixed VoIP phone service, location information cannot always be tracked by a dispatcher in a public safety answering point (PSAP), call back is not always possible, and address registration may be required upon purchase of the equipment. When the VoIP phone is moved to a new location, the emergency call will still be sent based on the registered address. The registered address can be changed, but delays are at least on the order of days or weeks in updating the information at the PSAP. In addition, some users might not update their registration information in a timely manner, if at all. This situation worsens with more mobility as enabled by VoIP phones using WLANs or WMANs. In particular, WMAN-based VoIP phones can work from any location inside coverage areas of the WMAN and the user may roam seamlessly between different WMAN coverage areas, such as from one city to another.

Moreover, for WMAN access network, no call establishment or call admission control priorities for emergency calls currently exist and there is no means to distinguish an emergency call from a regular call. In addition, the location of a base station or a subscriber station (SS) is currently unknown to the network in a non-proprietary manner, even if the base station's identification can easily be determined. It is also not currently possible to map the caller's location in a non-proprietary manner.

With respect to network admission, an access-controlled WMAN may prevent emergency callers from establishing an emergency call if the caller is not authorized to enter the network. The normal connection procedure between an SS and a base station requires the SS to send an SS basic capability request (SBC-REQ) message, followed by authorization and security key exchange prior to associating the SS to the base station. If the SS is unable to indicate that it is making an emergency call, the SS would have to go through the entire registration procedure to determine if the SS could be admitted. For example, if an SS does not have a proper password or authentication credentials to access the system, the base station may bluntly refuse the SS's association request. Even though the SS has a proper password or authentication credentials, the base station may still refuse admittance to the network based on its configured maximum capacity for voice users. In this case, the correct decision for the base station would be to admit this emergency call (at the highest priority) and to discontinue another existing voice call. Because the base station currently lacks means to make this distinction, such a feature cannot be implemented in a conventional WMAN.

### SUMMARY

The present invention is related to a method and apparatus for supporting an emergency call in a wireless communication system including a WMAN. A wireless transmit/receive unit (WTRU) sends an emergency call message to a base station of the WMAN to make an emergency call along with an emergency call indication. The base station then admits the emergency call with or without performing a security procedure and connects the WTRU to an emergency call center. The base station and the WTRU may communicate capability information regarding support of emergency calls. Location information of the WTRU is also forwarded to the emergency call center. The base station may work as a proxy for the WTRU if the WTRU does not have all the required functionalities to complete the emergency call. The WTRU may be a multi-mode WTRU capable of communicating with two or more radio access networks (RANs).

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a signaling diagram of a process for placing an emergency call in accordance with the present invention;

FIG. 2 is a flow diagram of a process for placing an emergency call with a multi-mode WTRU in a wireless communication system including a cellular network and a WMAN in accordance with the present invention;

FIG. 3 is a block diagram of a WTRU in accordance with the present invention; and

FIG. 4 is a block diagram of a base station in accordance with the present invention.

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present invention is applicable to any WMANs including, but not limited to, IEEE 802.16 or IEEE 802.20 WMANs. The present invention is also applicable to mesh networks or ad-hoc networks.

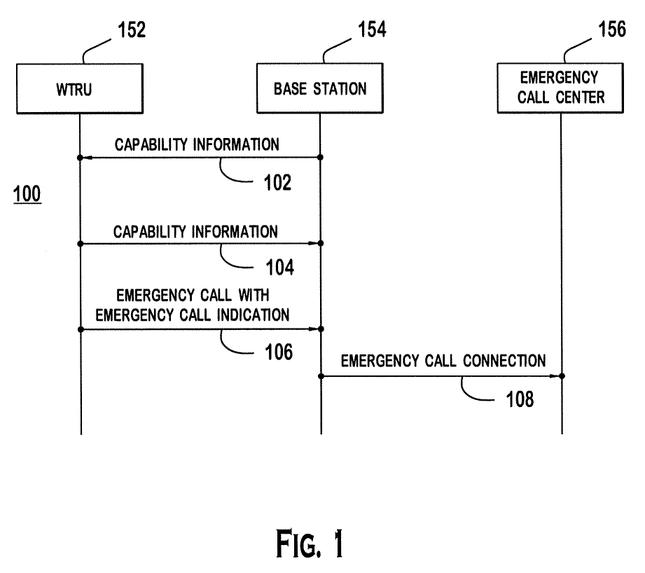

FIG. 1 is a signaling diagram of a process 100 for placing an emergency call in accordance with the present invention. A base station 154 which is a part of a WMAN may broadcast its capability information regarding support of emergency calls (step 102). The base station 154 may also broadcast an indication whether the emergency call capability in the base station 154 is presently active. If the emergency call capability is not supported by the base station or is not currently active, a WTRU 152 should attempt to place an emergency call via another base station. The capability information sent by the base station 154 may be included in any message including, but not limited to, an association response message, an authentication response message, an SBC-RSP message, or the like.

The capability information provided by the base station 154 may also include capability information of the WMAN that the base station 154 belongs to. The WMAN may or may not have the capability to connect to an emergency call center 156. For example, the WMAN might be configured just as a data collection network, (e.g., a factory telemetry network), and might not have an Internet connection which would permit the base station 154 to connect to the emergency call center 156. In such case, the base station 154 informs the WTRU 152 that the WMAN cannot support emergency calls, so that the WTRU 152 should attempt to place the emergency call via another WMAN. The base station 154 informs the same when the WMAN's Internet connection is temporarily unavailable.

The WTRU 152 may also send its capability information to the base station 154 (step 104). The capability information sent by the WTRU 152 may be included in any message including, but not limited to, an association request message, an authentication request message, an SBC-REQ message, or the like. A centralized database in the WMAN may be automatically updated with the new capability information of the WTRU 152 such that this capability information is readily available when the user places an emergency call. This reduces latency that would otherwise be required to complete the call by having to exchange the capability information across the network.

The exchange of the capability information is performed as an optional feature, and the capability information of the WTRU may be sent at the time of, or after, placing an emergency call.

When a user of the WTRU 152 places an emergency call through the WMAN, an emergency call indication is also sent to the base station 154 (step 106). The emergency call indication may be provided by any means. For example, the emergency call indication may be provided by using service flow identification (SFID) indicating that the call is an emergency call. Alternatively, a quality of service (QoS) parameter, (e.g., service class), may be used to indicate that the call is an emergency call. The emergency call indication may be carried in any part of a medium access control (MAC) frame, (e.g., header or body). An Ethernet type field of the MAC frame may also be used for the emergency call indication. The MAC frame may be a control frame, a management frame or a data frame.

Each base station has its own base station identity (BSID) and each MAC frame includes a BSID. As an alternative for the emergency call indication, one BSID, (emergency BSID), may be reserved for emergency calls only, and the emergency BSID is included in the MAC frame when a user attempts to make an emergency call. The WTRU 152 receives the emergency BSID from the base station 154 and uses it for placing an emergency call. For example, the emergency BSID may be included in an SS basic capability response (SBC-RSP) frame.

After receiving the emergency call message along with the emergency call indication, the base station 154 admits the WTRU 152 and connects the WTRU 152 to the emergency call center 156 giving priority to the emergency call (step 108). The base station 154 may bypass security procedures and/or may work as a proxy for the WTRU 152, which will be explained in detail hereinafter.

When the base station 154 connects the WTRU 152 to the emergence call center, the base station 154 forwards location information of the WTRU 152 to the emergency call center 156 at step 108. The location information of the WTRU 152 may be obtained by the base station 154. Alternatively, the location information may be obtained by the WTRU 152 and forwarded to the base station 154.

The location information may be attached to the emergency call message at step 106. Alternatively, the location information may be conveyed separately from the emergency call. The base station 154 may poll the location information from the WTRU 152. Alternatively, the WTRU 152 may periodically or non-periodically report location information to the base station 154 regardless of the emergency call. Maintaining location information of the WTRU 152 at the base station 154 is preferable because when the WTRU 152 issues the emergency call, the base station 154 already has a reasonably recent estimate of the WTRU's location, such that the WTRU 152 may not be required to piggyback its location information onto the emergency call signaling message.

The WTRU 152 may be located by using at least one of a basic service set ID (BSSID), a MAC address of the base station 154 or the WTRU 152, an IP address of the WTRU 152, a network ID, global positioning system (GPS) information, an assisted GPS coordinate, uplink time difference of arrival (U-TDOA), enhanced observed time difference (E-OTD), idle period downlink observed time difference of arrival (IPDL-OTDOA), universal geographic coordinates, (e.g., as defined in IETF RFC 3825), and base station location, cell site or sector information, and timing advance or roundtrip time measurements.

The base station 154, recognizing that the WTRU 152 is capable of using emergency call services and has a need to make an emergency call with the emergency call indication, may bypass normal security procedures. The security procedures may be entirely bypassed and the emergency call may be admitted without requiring authentication. Alternatively, the emergency call may be admitted with different security settings. For example, the emergency call may be provided with a special emergency-related access code, security key or an authentication credential. With this scheme, a WTRU with even no credentials may access the network to make an emergency call.

In order to prevent an abuse of the security bypass from calls pretending to be emergency calls, (e.g., through spoofing signaling information), semi-static routing may be performed for all emergency calls, such that all emergency calls are automatically routed to the emergency call center 156 without providing general access to the WMAN. By using semi-static routing for emergency calls, even spoofed emergency calls would be routed to the emergency call center 156.

The base station 154, (or any other network entity), may implement a call back functionality to handle emergency calls. Once an emergency call is established, the WMAN maintains an active connection to the user that initiated the emergency call for a certain period after the emergency call is over in case of call back. This functionality may be transparent to the user.

The base station 154 may work as a proxy for the WTRU 152. After receiving the emergency call, the base station 154 determines whether the WTRU 152 has all the required functionalities, (e.g., session initiation protocol (SIP)/H.323 protocol termination, vocoder, or the like), to complete the emergency call based on the network to be used to carry the emergency call. This may be performed based on the capability information received from the WTRU 152 or subscriber information in the network.

If the WTRU 152 has all the necessary functionalities, the base station 154 proceeds with the emergency call as normal. If the WTRU 152 does not have all the necessary functionalities to complete the emergency call, the base station 154 acts as a proxy for the WTRU 152, providing any necessary functionality. For example, if the WTRU 152 does not have session initiation protocol (SIP) functionality, the base station 154 may act as an SIP proxy for the WTRU 152. As another example, if the WTRU 152 has an SIP functionality but the network only supports H.323, the base station 154 may interwork the SIP messages from the WTRU 152 to H.323 messages to the rest of the network, and vice versa. In the extreme case that the WTRU 152 does not even have a vocoder, the base station 154 may download a thin vocoder client to the WTRU 152 and interwork to standard vocoders elsewhere in the network.

The base station 154 does not have to provide all the proxy functionalities for the WTRU 152. These functionalities may be provided by another entity in the network, (e.g., a dedicated gateway node). Moving the proxy functionalities out of the base station 154 provides greater flexibility to the WMAN to handle the emergency call in the event of an interruption in the WMAN's Internet connection.

In performing as a proxy, the base station 154 may spoof, (i.e., reads the contents and/or type information), on the contents of the signaling or traffic packets of the WTRU 152 and the network. For example, SIP signaling protocol messages over IP are typically used for call handling. Such SIP signaling contains useful information, such as capability information and destination addresses, for the base station to fulfill its role as proxy. The base station 154 may extract such information by spoofing on the message contents for fulfilling its role as a proxy. It should be noted that SIP is one example of a management protocol for IP-based calls and the spoofed message may be any other protocols messages.

The base station 154 needs to establish a link to the emergency call center 156 in order to properly route the emergency call from the WTRU 152. There are several possible transfer mechanisms to get the emergency call from the base station 154 to the emergency call center 156. The base station 154 may communicate with an emergency network node, (e.g., a gateway), linking it to the emergency call center 156.

The emergency network node may be an emergency response operations center with man-in-the-loop capability. For example, on a university campus, the emergency network node may be a campus police department. As another example, in a manufacturing plant, the emergency network node may be a security office. The emergency network node may have an operator who can receive the call, log call information, screen calls, and then place an emergency call on a public switched telephone network (PSTN) to alert appropriate authorities.

The emergency network node may be an automated node with a direct line to a PSTN. The automated node acts as a voice circuit bridge to dial and connect the caller to the emergency call center 156.

The emergency network node may have functionalities for call handoff and roaming coordination. The emergency network node may preauthorize resources in neighbor base stations so that the caller may roam without losing the wireless connection and without the need to reestablish a new emergency call when moving across cell boundaries.

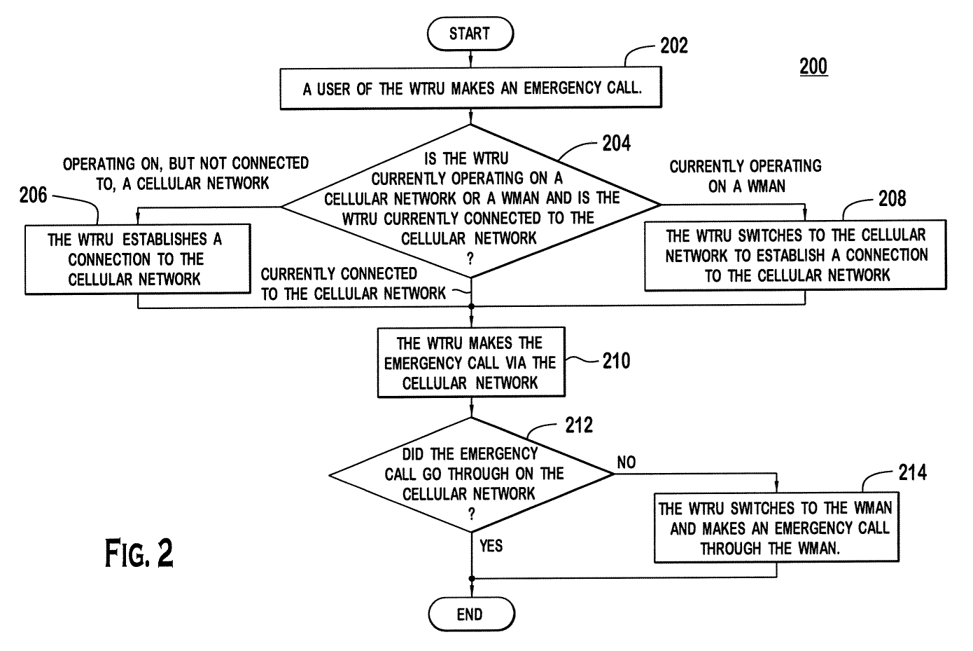

FIG. 2 is a flow diagram of a process 200 for placing an emergency call with a multi-mode WTRU in a wireless communication system including a cellular network and a WMAN in accordance with the present invention. The WTRU is a multi-mode WTRU that is capable of supporting two or more radio access technologies, (e.g., a third generation (3G) and WMAN, or a WMAN and WLAN). In accordance with one embodiment of the present invention, the WTRU attempts to place an emergency call first on the cellular network. It is preferable to make an emergency call via a cellular network because currently emergency call support may not be available or may be less reliable over the WMAN.

A user of the WTRU makes an emergency call (step 202). It is then determined whether the WTRU is currently operating on a cellular network or a WMAN and whether the WTRU is currently connected to the cellular network (step 204). If the WTRU is operating on a cellular network and currently connected to the cellular network, the WTRU makes the emergency call via the cellular network (step 210). If the WTRU is currently operating on a cellular network, but not presently connected to the cellular network, the WTRU establishes a connection to the cellular network and makes an emergency call via the cellular network (steps 206, 210). If the WTRU is currently operating on the WMAN, the WTRU switches to the cellular network to establish a connection to the cellular network and makes an emergency call via the cellular network (steps 208, 210). After the emergency call is placed on the cellular network, the emergency call may be moved to a conventional circuit-switched voice channel. Alternatively, a VoIP call may be maintained on the cellular network.

After the emergency call has been placed, it is determined whether the emergency call went through on the cellular network (step 212). If so, the process ends. If the emergency call did not go through on the cellular network, the WTRU switches to the WMAN and makes an emergency call through the WMAN (step 214).

The configuration, (i.e., emergency network type to be used, address information, priority lists, timers, or the like), for placing the emergency call may be a “hard-coded” in the WTRU, (e.g., on a subscriber identity module (SIM) card or similar device of the WTRU). Alternatively, a system operator may signal a preferred order of radio technologies to place an emergency call. Alternatively, the WTRU may be configured by parameters received from the base station through a separate configuration procedure or during initial or subsequent network access. Alternatively, the user may manually configure the WTRU. It should be noted that the descriptions for the dual-mode WMAN-cellular WTRU is provided as an example, and it may be extended to many other similar dual-mode implementations, such as WLAN-WMAN dual-mode WTRUs.

The emergency call functionalities described hereinbefore may be implemented by any network entity. For example, these functionalities may be implemented by the WTRU, by an access controller of the network, or by a call server, or may be distributed across several APs.

The present invention may be extended to machine-to-machine scenarios, instead of a human user, for emergency handling with WMANs. For example, for home security systems, instead of a human user generating a WMAN emergency call, the home security system may automatically generate an emergency call to the emergency call center, (for example when someone breaks in).

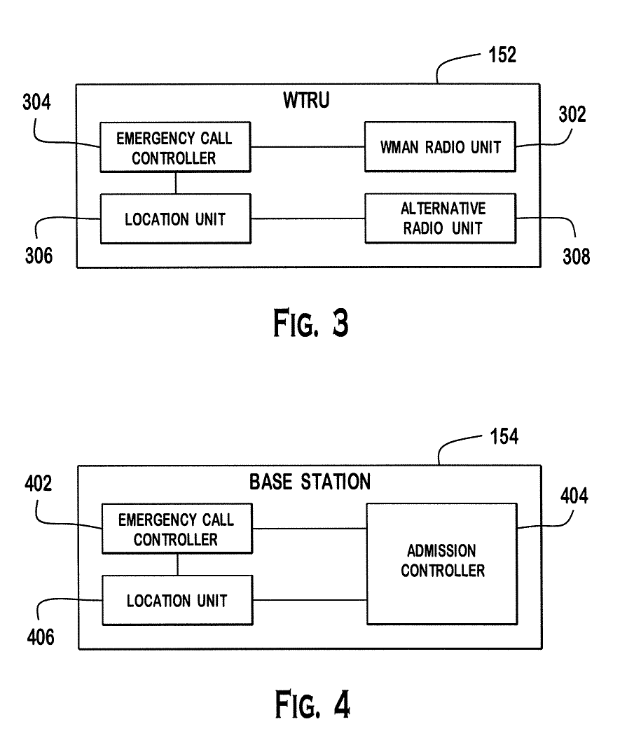

FIG. 3 is a block diagram of a WTRU 152 in accordance with the present invention. The WTRU includes a WMAN radio unit 302, an emergency call controller 304, a location unit 306, and an optional alternative radio unit 308. The WMAN radio unit 302 is for wirelessly communicating with the WMAN. The emergency call controller 304 sends an emergency call message to a base station of the WMAN along with an emergency call indication to make an emergency call as stated hereinbefore. The location unit 306 generates location information of the WTRU which is conveyed to the base station. If the WTRU 152 is a multi-mode WTRU, the WTRU 152 includes at least one alternative radio unit 308.

FIG. 4 is a block diagram of a base station 154 in accordance with the present invention. The base station 154 includes an emergency call controller 402, an admission controller 404 and a location unit 406. When an emergency call message is received from the WTRU along with an emergency call indication, the admission controller 404 performs admission control of the emergency call. The admission controller 404 may admit the emergency call without performing authentication as explained hereinbefore. Once the emergency call is admitted, the emergency call controller 402 connects the WTRU to an emergency call center. The location unit 406 generates location information of the WTRU and the emergency call controller 402 forwards the location information to the emergency call center.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for supporting an emergency call in a wireless communication system including a wireless metropolitan area network (WMAN), the method comprising:
a wireless transmit/receive unit (WTRU) sending an emergency call message to a base station of the WMAN to make an emergency call along with an emergency call indication;
the base station admitting the emergency call; and
the base station connecting the WTRU to an emergency call center.

2. The method of claim 1 further comprising:
the base station broadcasting capability information of the base station regarding support of emergency calls, wherein the WTRU sends the emergency call message only if the base station has emergency call capability.

3. The method of claim 2 further comprising:
the base station broadcasting an indication whether the emergency call capability in the base station is presently active, wherein the WTRU sends the emergency call message only if the emergency call capability is active.

4. The method of claim 2 wherein the capability information is included in one of an association response message, an authentication response message, a subscriber station basic capability response (SBC-RSP) message.

5. The method of claim 2 wherein the capability information include capability information of the WMAN that the base station belongs to.

6. The method of claim 1 further comprising:
the WTRU sending capability information of the WTRU to the base station.

7. The method of claim 6 wherein the capability information is included in one of an association request message, an authentication request message, a subscriber station basic capability request (SBC-REQ) message.

8. The method of claim 7 further comprising:
updating a centralized database in the WMAN with the capability information of the WTRU.

9. The method of claim 1 wherein the emergency call indication is provided by using service flow identification (SFID) indicating that the call is an emergency call.

10. The method of claim 1 wherein the emergency call indication is provided by using a quality of service (QoS) parameter to indicate that the call is an emergency call.

11. The method of claim 1 wherein the emergency call indication is carried by a medium access control (MAC) frame.

12. The method of claim 11 wherein the MAC frame is one of a control frame, a management frame and a data frame.

13. The method of claim 1 wherein an emergency base station identification (BSID) is reserved for the base station, and the emergency call indication is provided by using the emergency BSID.

14. The method of claim 13 wherein the emergency BSID is provided to the WTRU by using a subscriber station basic capability response (SBC-RSP) message.

15. The method of claim 1 wherein the base station admits the emergency call without performing authentication of the WTRU.

16. The method of claim 1 wherein the base station admits the emergency call with security settings different from a non-emergency call.

17. The method of claim 15 wherein the emergency call is routed to the emergency call center semi-statically without providing a general access to the WMAN.

18. The method of claim 1 wherein the WMAN maintains an active connection to the WTRU for a predetermined period after the emergency call is over.

19. The method of claim 1 wherein the base station forwards location information of the WTRU to the emergency call center.

20. The method of claim 19 wherein the location information of the WTRU is obtained by one of the base station and the WTRU.

21. The method of claim 20 wherein the WTRU attaches the location information to the emergency call message.

22. The method of claim 20 wherein the WTRU conveys the location information to the base station separately from the emergency call.

23. The method of claim 20 wherein the base station polls for the location information from the WTRU.

24. The method of claim 20 wherein the WTRU reports location information to the base station.

25. The method of claim 20 wherein the location information is generated based on at least one of a basic service set identity (BSSID), a medium access control (MAC) address of the base station and the WTRU, an Internet protocol (IP) address of the WTRU, a network identity, global positioning system (GPS) information, an assisted GPS coordinate, uplink time difference of arrival (U-TDOA), enhanced observed time difference (E-OTD), idle period downlink observed time difference of arrival (IPDL-OTDOA), universal geographic coordinates, base station location, cell site information, sector information, timing advance measurement, and roundtrip time measurement.

26. The method of claim 1 further comprising:
the base station determining whether the WTRU has all the required functionalities to complete the emergency call; and
if the WTRU does not have all the necessary functionalities to complete the emergency call, the base station acting as a proxy for the WTRU providing any necessary functionality.

27. The method of claim 26 wherein the base station makes the determination based on the capability information received from the WTRU.

28. The method of claim 26 wherein the base station makes the determination based on subscriber information in the WMAN.

29. The method of claim 26 wherein the base station acts as a session initiation protocol (SIP) proxy for the WTRU.

30. The method of claim 26 wherein the base station interworks between session initiation protocol (SIP) messages and H.323 messages.

31. The method of claim 26 wherein the base station downloads a thin vocoder client to the WTRU and interworks to standard vocoders in the network.

32. The method of claim 26 wherein at least a portion of the functionalities is provided by a network entity in the WMAN.

33. The method of claim 26 wherein the base station spoofs on contents of packets of the WTRU for performing as a proxy for the WTRU.

34. The method of claim 1 wherein the base station communicates with an emergency network node which links the base station to the emergency call center.

35. The method of claim 34 wherein the emergency network node is an emergency response operations center with man-in-the-loop capability.

36. The method of claim 34 wherein the emergency network node is an automated node.

37. The method of claim 36 wherein the automated node acts as a voice circuit bridge to dial and connect the WTRU to the emergency call center.

38. The method of claim 34 wherein the emergency network node has functionalities for call handoff and roaming coordination.

39. The method of claim 38 wherein the emergency network node preauthorizes resources in neighbor base stations so that the user of the WTRU may roam without losing wireless connection.

40. The method of claim 1 wherein the WTRU is a multi-mode WTRU capable of communicating with at least two wireless networks.

41. The method of claim 40 wherein the WTRU is configured to communicate with a cellular network and a WMAN.

42. The method of claim 40 wherein the WTRU is configured to communicate with a WMAN and a wireless local area network (WLAN).

43. The method of claim 41 wherein the WTRU attempts to place an emergency call first on the cellular network and places the emergency call on the WMAN only if it fails to place to the emergency call on the cellular network.

44. The method of claim 40 wherein an order to place the emergency call among a plurality of wireless networks is hard-coded in the WTRU.

45. The method of claim 40 wherein an order to place the emergency call among a plurality of wireless networks is configured by a system operator.

46. The method of claim 40 wherein an order to place the emergency call among a plurality of wireless networks is configured by the base station.

47. The method of claim 40 wherein an order to place the emergency call among a plurality of wireless networks is configured by the user manually.

48. The method of claim 1 wherein the emergency call is made by a user of the WTRU.

49. The method of claim 1 wherein the emergency call is made by the WTRU autonomously.

50. The method of claim 1 wherein the WMAN is one of an IEEE 802.16 network and an IEEE 802.20 network.

51. A wireless transmit/receive unit (WTRU) for making an emergency call in a wireless communication system including a wireless metropolitan area network (WMAN), the WTRU comprising:
a WMAN radio unit for wirelessly communicating with the WMAN; and
an emergency call controller for sending an emergency call message to a base station of the WMAN along with an emergency call indication to make an emergency call.

52. The WTRU of claim 51 wherein the emergency call controller sends the emergency call message only if the base station has emergency call capability based on capability information broadcast by the base station.

53. The WTRU of claim 52 wherein the emergency call controller sends the emergency call message only if the emergency call capability of the base station is active.

54. The WTRU of claim 52 wherein the emergency call controller sends the emergency call message only if the WMAN that the base station belongs to supports an emergency call capability.

55. The WTRU of claim 51 wherein the emergency call controller is configured to send capability information of the WTRU to the base station.

56. The WTRU of claim 55 wherein the capability information is included in one of an association request message, an authentication request message, a subscriber station basic capability request (SBC-REQ) message.

57. The WTRU of claim 51 wherein the emergency call indication is provided by using service flow identification (SFID) indicating that the call is an emergency call.

58. The WTRU of claim 51 wherein the emergency call indication is provided by using a quality of service (QoS) parameter to indicate that the call is an emergency call.

59. The WTRU of claim 51 wherein the emergency call indication is carried by a medium access control (MAC) frame.

60. The WTRU of claim 59 wherein the MAC frame is one of a control frame, a management frame and a data frame.

61. The WTRU of claim 51 wherein the emergency call indication is provided by using an emergency base station identification (BSID) reserved for the base station.

62. The WTRU of claim 51 further comprises:
a location unit for generating location information of the WTRU, wherein the location information is conveyed to the base station.

63. The WTRU of claim 62 wherein the emergency call controller attaches location information of the WTRU to the emergency call message.

64. The WTRU of claim 62 wherein the emergency call controller sends location information of the WTRU to the base station separately from the emergency call.

65. The WTRU of claim 62 wherein the emergency call controller sends location information of the WTRU in response to a poll by the base station.

66. The WTRU of claim 62 wherein the location unit generates the location information based on at least one of a basic service set identity (BSSID), a medium access control (MAC) address of the base station and the WTRU, an Internet protocol (IP) address of the WTRU, a network identity, global positioning system (GPS) information, an assisted GPS coordinate, uplink time difference of arrival (U-TDOA), enhanced observed time difference (E-OTD), idle period downlink observed time difference of arrival (IPDL-OTDOA), universal geographic coordinates, base station location, cell site information, sector information, timing advance measurement, and roundtrip time measurement.

67. The WTRU of claim 51 further comprising:
at least one alternative radio unit for wirelessly communicating with an alternative wireless network.

68. The WTRU of claim 67 wherein the alternative radio unit is a cellular radio unit for communicating with a cellular network.

69. The WTRU of claim 67 wherein the alternative radio unit is a wireless local area network (WLAN) radio unit.

70. The WTRU of claim 67 wherein the emergency call controller attempts to place an emergency call first on the cellular network and place the emergency call on the WMAN only if it fails to place to the emergency call on the cellular network.

71. The WTRU of claim 67 wherein an order to place the emergency call among a plurality of wireless networks is hard-coded in the WTRU.

72. The WTRU of claim 67 wherein an order to place the emergency call among a plurality of wireless networks is configured by a system operator.

73. The WTRU of claim 67 wherein an order to place the emergency call among a plurality of wireless networks is configured by the base station.

74. The WTRU of claim 67 wherein an order to place the emergency call among a plurality of wireless networks is configured by a user manually.

75. The WTRU of claim 51 wherein the emergency call controller sends the emergency call message in response to a user's input.

76. The WTRU of claim 51 wherein the emergency call controller sends the emergency call message autonomously.

77. A base station for supporting an emergency call in a wireless communication system including a wireless metropolitan area network (WMAN), the base station comprising:
an admission controller for performing an admission control of an emergency call received from a wireless transmit/receive unit (WTRU) along with an emergency call indication; and
an emergency call controller configured to connect the WTRU to an emergency call center if the emergency call is admitted.

78. The base station of claim 77 wherein the emergency call controller broadcasts capability information of the base station regarding support of emergency calls.

79. The base station of claim 78 wherein the emergency call controller broadcasts an indication whether the emergency call capability in the base station is presently active.

80. The base station of claim 78 wherein the capability information is included in one of an association response message, an authentication response message, a subscriber station basic capability response (SBC-RSP) message.

81. The base station of claim 78 wherein the capability information include capability information of the WMAN that the base station belongs to.

82. The base station of claim 77 wherein the emergency call indication is provided by using service flow identification (SFID) indicating that the call is an emergency call.

83. The base station of claim 77 wherein the emergency call indication is provided by using a quality of service (QoS) parameter to indicate that the call is an emergency call.

84. The base station of claim 77 wherein the emergency call indication is carried by a medium access control (MAC) frame.

85. The base station of claim 77 wherein the emergency call controller provides an emergency base station identification (BSID) reserved for the base station to the WTRU, wherein the emergency call indication is indicated by using the emergency BSID.

86. The base station of claim 77 wherein the admission controller admits the emergency call without performing authentication of the WTRU.

87. The base station of claim 77 wherein the admission controller admits the emergency call with security settings different from a non-emergency call.

88. The base station of claim 86 wherein the emergency call is routed to the emergency call center semi-statically without providing a general access to the WMAN.

89. The base station of claim 77 wherein the emergency call controller maintains an active connection to the WTRU for a predetermined period after the emergency call is over.

90. The base station of claim 77 wherein the emergency call controller forwards location information of the WTRU to the emergency call center.

91. The base station of claim 90 wherein the emergency call controller polls for the location information from the WTRU.

92. The base station of claim 90 further comprising:
a location unit for obtaining location information of the WTRU based on at least one of a basic service set identity (BSSID), a medium access control (MAC) address of the base station and the WTRU, an Internet protocol (IP) address of the WTRU, a network identity, global positioning system (GPS) information, an assisted GPS coordinate, uplink time difference of arrival (U-TDOA), enhanced observed time difference (E-OTD), idle period downlink observed time difference of arrival (IPDL-OTDOA), universal geographic coordinates, base station location, cell site information, sector information, timing advance measurement, and roundtrip time measurement.

93. The base station of claim 77 wherein the emergency call controller determines whether the WTRU has all the required functionalities to complete the emergency call and if the WTRU does not have all the necessary functionalities to complete the emergency call, the base station acts as a proxy for the WTRU providing any necessary functionality.

94. The base station of claim 93 wherein the emergency call controller makes the determination based on the capability information received from the WTRU.

95. The base station of claim 93 wherein the emergency call controller makes the determination based on subscriber information in the WMAN.

96. The base station of claim 93 wherein the base station acts as a session initiation protocol (SIP) proxy for the WTRU.

97. The base station of claim 93 wherein the base station interworks between session initiation protocol (SIP) messages and H.323 messages.

98. The base station of claim 93 wherein the emergency call controller downloads a thin vocoder client to the WTRU and interworks to standard vocoders in the network.

99. The base station of claim 93 wherein the emergency call controller spoofs on contents of packets of the WTRU for performing as a proxy for the WTRU.
